(19) United States
(12) Patent Application Publication
(10) Pub. No.: US 2010/0161950 A1
(43) Pub. Date: Jun. 24, 2010

(54) SEMI-ABSOLUTE BRANCH INSTRUCTIONS FOR EFFICIENT COMPUTERS

(75) Inventors: Paul Caprioli, Santa Clara, CA (US); Peter B. Kessler, Palo Alto, CA (US); Christopher A. Vick, San Jose, CA (US)

Correspondence Address: PVF -- SUN MICROSYSTEMS INC.;C/O PARK, VAUGHAN & FLEMING LLP, 2820 FIFTH STREET, DAVIS, CA, 95618-7759, US

(73) Assignee: SUN MICROSYSTEMS, INC., Santa Clara, CA (US)

(21) Appl. No.: 12/344,151

(22) Filed: Dec. 24, 2008

(51) Int. Cl. G06F 9/30

(52) U.S. Cl. 712/234; 712/E09.016

(57) ABSTRACT

Apparatus and methods are disclosed for a computation processor that can execute a semi-absolute branch instruction, as well as methods of operation and of generating the semi-absolute branch instruction.

### BACKGROUND

1. Technical Field

This disclosure is generally related to the field of computers. More specifically, this disclosure relates to computer architecture.

2. Related Art

One skilled in the art will understand pipelined computer architectures. Each pipeline generally includes a fetch, decode, execute, access and write-back stage. One problem that needs to be addressed when designing pipelined computer architectures is how to minimize pipeline bubbles when a branch instruction is fetched. Once a bundle of instructions is fetched, the branch instructions in the bundle can be identified, predicted, and the branch target address determined. Since prediction often occurs in parallel with address computation, sometimes multiple address adders are provided so that the first predicted-taken branch's target address is available even if a previous branch in the bundle is predicted not-taken. Moreover, this address computation is often repeated in the branch execution unit to handle the case of an incorrectly predicted branch.

FIG. 1 illustrates a program-counter relative-branch computer instruction 100 as is known in the art. The program-counter relative-branch computer instruction 100 is a sequence of bits in memory 101 that includes an opcode portion 103 and a program-counter relative-offset operand 105. The opcode portion 103 is used by the computation processor to identify the instruction as a branch and can also specify what conditions are required to invoke a branch. The program-counter relative-offset operand 105 contains a value that is added to the program-counter of that instruction to calculate the branch target address used if the branch is taken.

For example, in the SPARC-v9 specification, a program-counter relative-effective address is computed by sign extending the instruction's immediate field to 64 bits, left-shifting the word displacement by two bits to create a byte displacement, and adding the result to the program-counter.

As known to one skilled in the art, the program-counter relative-branch computer instruction 100 can be implemented in a computation processor. FIG. 2 illustrates such an implementation. A prior art pipeline 200 generally includes a fetch stage 201, an execution stage 203, and other stages that are not shown. The fetch stage 201 is in communication with an instruction cache 205, a branch predictor cache 207, and an array of adders 209. The instruction cache 205 (and its associated instruction fetch logic) is used by the fetch stage 201 to receive a bundle of instructions responsive to the provided virtual program-counter (VPC) and physical program-counter (PPC) (the program-counter covers the bundle of instructions that are retrieved from the instruction cache 205). The bundle of instructions is returned to the fetch stage 201. The fetch stage 201 then identifies whether the bundle of instructions includes one or more program-counter relative-branch instructions.

Branch prediction information related to the virtual program-counter (and its corresponding bundle of instructions) is returned to the fetch stage 201 and used to predict whether or not branches will be taken by the program-counter relative-branch instructions (if any exist in the bundle of instructions). If branches are predicted, the virtual program-counter and the program-counter relative-offset operand 105 of the predicted branches are provided to the array of adders 209 (one VPC and offset for each branch that is being simultaneously predicted) to calculate the branch target address if the branch is taken. If the branch is predicted, the fetch stage 201 can fetch a new bundle of instructions covered by the predicted virtual program-counter (the branch target address). The maximum number of branch instructions within the bundle of instructions that can be simultaneously predicted is the number of adders in the array of adders 209. The bundle of instructions returned to the fetch stage 201 generally does not cross a page boundary in memory.

Eventually, the program-counter relative-branch instruction reaches the execution stage 203 where the opcode portion 103 of the program-counter relative-branch computer instruction 100 is decoded and the branch conditions evaluated. If the branch is taken, the program-counter and the program-counter relative-offset operand 105 for the branch are submitted to a branch unit adder 211 that again calculates the new branch target address. If the branch was correctly predicted, the fetch stage 201 and associated instruction fetch logic will have already moved the bundle of instructions covered by the branch target address into the pipeline.

Thus, for a 64-bit computation processor that can branch-predict two instructions in the bundle of instructions, there can be three 64-bit adders. Each of these adders consumes chip real-estate and power. In addition, the operation of the adders is a source of latency.

In some implementations, the 64-bit adders are replaced by partial adders of sufficient length to accommodate the maximum displacement (which is determined by the number of bits in the program-counter relative-offset operand 105). In such implementations the higher bit-range of the virtual program-counter is incremented or decremented (thus, the higher bit-range of the program-counter has been subjected to an incremental change) responsive to the partial adder's overflow and carry conditions. For example, if the program-counter relative-offset operand 105 is 19 bits, the partial adder would be 19 bits, and the incrementer would be 43 bits. This incrementer logic and 19-bit adder consume less chip real-estate and power than the pure adder implementation.

The virtual program-counter is also provided to a page translation logic 213 that includes a page transition logic 215. The page translation logic 213 provides a physical page select or physical program-counter to the instruction cache 205. In many implementations of the page translation logic 213, the provided physical page select (or the higher bit-range of the physical program-counter) remains the same while the virtual program-counter is within the same memory page and is only freshly determined when a page transition is detected by the page transition logic 215.

Some computation processor implementations allow branches to absolute addresses. This type of branch instruction generally uses a value in a register or a word following the absolute branch instruction as the branch target address. In such computers, the program instructions need to be “relocated” if the program is loaded into memory other than at an expected address. A linker program can be used to generate a load file from object files and object libraries. A relocating loader can adjust the absolute instructions in the load file responsive to where the instructions are loaded in physical memory.

Program-counter relative-branch instructions enable position-independent code. Position-independent code can be executed from any memory address without relocation because the branch target address is referenced with respect to the instruction's current program-counter. The use of position-independent code simplifies the loading process and also enables sharing of memory-resident library code among simultaneously executing applications.

A computation processor with virtual memory capability enables the address space of an application to appear contiguous even though the physical memory used by the application may be physically fragmented throughout the computation processor's storage. Virtual memory implementations generally divide the application's virtual address space into blocks of contiguous virtual memory addresses. These blocks are termed “pages.” Page tables are often used to translate the virtual addresses seen by the application program into physical addresses used by the hardware. Each entry in a page table can contain the starting virtual address of the page and the mapped-to physical address of the page. Most virtual memory implementations allow a page of physical memory to be swapped out to file storage when not in use. The contents of the swapped page can be read back from the file storage to a different page of physical memory (with appropriate updating of the page table entry so that while the physical address of the swapped page has changed, the address of the page in virtual space remains the same).

When a computation processor attempts to fetch an instruction located at a particular virtual address or, while executing an instruction, fetches data from a specific virtual address or stores data to a particular virtual address, the virtual address is translated to the corresponding physical address. This can be accomplished by the page translation logic 213 (memory mapping unit) which determines the physical address (from the page table) corresponding to the desired virtual address and passes the physical program counter (PPC) to the instruction cache 205. The page translation logic is usually controlled by the operating system of the computation processor.

Libraries are often shared and used by multiple programs at the same time. The programs can execute the same code from one copy of the library code in physical memory. If the shared code is position-independent and designed to execute in a multi-threaded environment, the shared code can be located anywhere in a program's virtual memory. However, sharing position-dependent code is more difficult.

One skilled in the art will understand memory page models as illustrated in FIG. 3. In FIG. 3, a sequence of instructions 300 resides across multiple pages. A first depicted page includes a branch instruction instance that has a branch target address within a third page. If, during execution, the branch instruction instance at x+8 is taken, then the page boundary transition requires a translation of a virtual address representation for the instruction instance at t+4, which is the branch target address of the branch instruction at the x+8 memory address. Page boundary transitions may also occur during linear execution. For example, execution flow from the instruction instance at x+12 to the instruction instance at x+16 is linear, but crosses a page boundary. Each of these page transitions requires an appropriate address translation. For power and latency reductions, it is useful to determine whether a branch target address is in the same page as the branch instruction itself.

It would be useful to minimize the logic required for processing program-counter relative-branch instructions and for determining when a branch instruction crosses a page boundary.

### SUMMARY

One embodiment of the present invention relates to a computing system. This computing system includes a memory capable of storing a semi-absolute branch instruction at a memory address, said semi-absolute branch instruction comprising a semi-absolute branch instruction opcode, a semi-absolute branch instruction partial address, and a semi-absolute branch instruction adjust bit. The computing system also includes a computation processor comprising: (1) a program-counter comprising a lower bit-range and a higher bit-range, said lower bit-range containing a lower program-counter value; (2) an instruction fetch logic responsive to the program-counter and configured to access said semi-absolute branch instruction from the memory at said memory address covered by said program-counter; (3) a first instruction decoder logic configured to recognize said semi-absolute branch instruction opcode; and (4) a first semi-absolute branch instruction logic, responsive to the first instruction decoder logic configured to replace said lower program-counter value of said lower bit-range of said program-counter with said semi-absolute branch instruction partial address.

In one embodiment, said higher bit-range contains a higher program-counter value and the instruction fetch logic further comprises: an incrementer array logic comprising a decrementer logic configured to provide a decremented higher bit-range value and an incrementer logic configured to provide an incremented higher bit-range value; and higher bit-range selection logic configured to select between said higher program-counter value, said decremented higher bit-range value and said incremented higher bit-range value responsive to said semi-absolute branch instruction partial address and said semi-absolute branch instruction adjust bit.

In one embodiment, the computation processor further comprises a page transition logic responsive to said semi-absolute branch instruction partial address and said semi-absolute branch instruction adjust bit.

In one embodiment, the computation processor further comprises: a second instruction decoder logic configured to recognize said semi-absolute branch instruction opcode; and a second semi-absolute branch instruction logic, responsive to said second instruction decoder logic configured to replace said lower program-counter value of said lower bit-range of said program-counter with said semi-absolute branch instruction partial address.

In one embodiment, said semi-absolute branch instruction adjust bit is one of a set of carry-out bits.

### BRIEF DESCRIPTION OF THE FIGURES

FIG. 1 illustrates a program-counter relative-branch computer instruction;

FIG. 2 illustrates a portion of a prior-art pipeline that can be used to process the program-counter relative-branch computer instruction illustrated in FIG. 1;

FIG. 3 illustrates an example of an instruction sequence with various page boundaries;

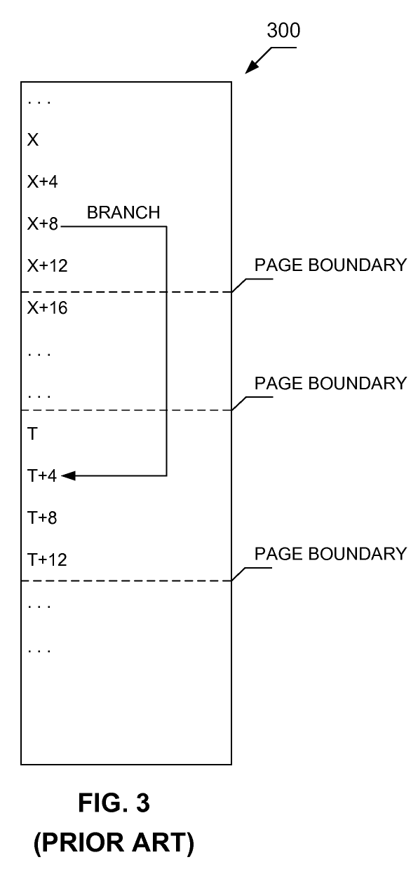

FIG. 4 illustrates a semi-absolute branch instruction;

FIG. 5 illustrates a portion of a pipeline that can be used to process the semi-absolute branch instruction illustrated in FIG. 4;

FIG. 6 illustrates page transition situations;

FIG. 7 illustrates a virtual machine loading process;

FIG. 8 illustrates a relocating loader process; and

FIG. 9 illustrates a colored memory page loading process.

### DETAILED DESCRIPTION

The technology disclosed herein teaches a computation processor that can execute a semi-absolute branch instruction as well as methods of operation and of generating the semi-absolute branch instruction.

The following description is presented to enable any person skilled in the art to make and use the disclosed technology, and is provided in the context of a particular application and its requirements. Various modifications to the disclosed embodiments will be readily apparent to those skilled in the art, and the general principles defined herein may be applied to other embodiments and applications without departing from the spirit and scope of that which is claimed. Thus, the present claims are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

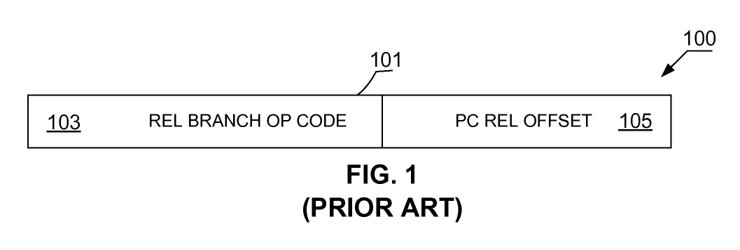

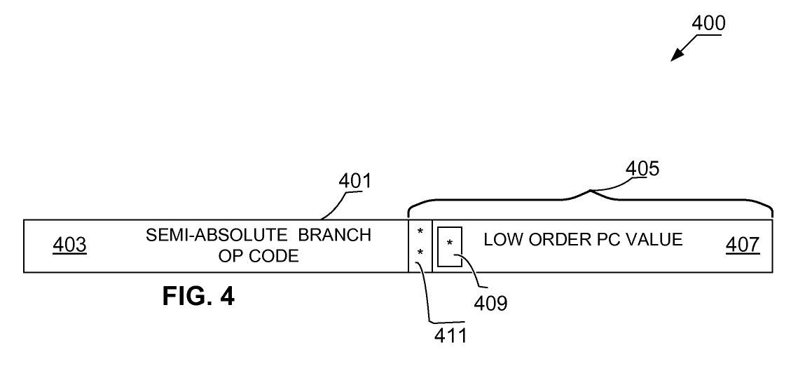

FIG. 4 illustrates a semi-absolute branch instruction 400 that can be stored in a memory at a memory address and executed by a computation processor. The semi-absolute branch instruction 400 is a sequence of bits in memory 401 (a data structure) and includes an opcode portion 403 and a semi-absolute branch instruction operand 405. The opcode portion 403 can contain a different opcode from the program-counter relative-branch opcode of FIG. 1. However, the semi-absolute branch instruction 400 can replace the program-counter relative-branch computer instruction 100 so that the contents of the opcode portion 103 and the opcode portion 403 can be identical. The semi-absolute branch instruction operand 405 includes a partial address 407 (including a partial address sign bit 409) and a semi-absolute branch instruction adjust bit 411. The value of the partial address 407 is a replacement value for the lower bit-range of the program-counter of the semi-absolute branch instruction 400 if the branch is taken.

Like the program-counter relative-branch instructions, the technology disclosed herein assumes a limited branch maximum displacement. However, instead of using the operand of the branch instruction for holding a program-counter relative-offset value, the disclosed technology uses the operand to hold a pre-computed lower portion of the branch target address. Thus, the branch target address is determined by replacing the lower bits of the program-counter of the instruction with the direct contents of the partial address 407 and performing an incremental change of the higher bit-range of the program-counter responsive to the partial address sign bit 409 and the semi-absolute branch instruction adjust bit 411. The semi-absolute branch instruction adjust bit 411 indicates whether the branch target address differs from the instruction's program-counter in the higher bit-range. If the semi-absolute branch instruction adjust bit 411 is enabled, the partial address sign bit 409 determines whether the higher bit-range of the program-counter of the instruction is incremented or decremented.

A computation processor implementation of the technology disclosed herein includes a program-counter (that has a lower bit-range and a higher bit-range) and an instruction fetch logic in communication with the program-counter. The instruction fetch logic is configured to access a semi-absolute branch instruction from a memory at the memory address covered by the program-counter. The semi-absolute branch instruction includes a semi-absolute branch instruction opcode, a semi-absolute branch instruction operand, and a semi-absolute branch instruction adjust bit. The computation processor includes a first instruction decoder logic that recognizes the semi-absolute branch instruction opcode and invokes a first semi-absolute branch instruction logic. The first semi-absolute branch instruction logic replaces the lower bit-range of the program-counter with the semi-absolute branch instruction partial address. The semi-absolute branch instruction adjust bit can reside in the semi-absolute branch instruction opcode or the semi-absolute branch instruction operand.

An example implementation of the semi-absolute branch instruction 400 can be based on the SPARC-v9 architecture. SPARC-v9 uses a 64-bit program-counter and includes a Branch on Integer Condition Codes with Prediction (BPcc) instruction family. The BPcc instructions use a 19-bit program-counter-relative operand and, thus, have a maximum displacement from the program-counter specified by 19 bits. Modifying the SPARC-v9 architecture to implement the semi-absolute branch instruction 400 can be accomplished, for example, by modifying the BPcc instructions so that the 19-bit program-counter displacement operand of the BPcc instructions is replaced by a one-bit semi-absolute branch instruction adjust bit 411 and an 18-bit partial address 407. The 64-bit program-counter has bits [17-0] designated as the lower bit-range and bits [63-18] designated as the higher bit-range. Such a SPARC-based implementation of the disclosed technology would have a maximum displacement of 18 bits (because the semi-absolute branch instruction adjust bit 411 is needed, and in this example that bit is taken from the maximum displacement). This example modification to the SPARC architecture implies a corresponding change to the code generator for SPARC compilers to accommodate the reduced maximum displacement. Other example implementations could use a reserved bit from the opcode portion 103 as the semi-absolute branch instruction adjust bit 411. In such an implementation, the maximum displacement need not be reduced. In other computation processor architectures, if opcode bit space is available, the semi-absolute branch instruction adjust bit 411 could be located in the opcode portion 103 of the branch instruction.

Note that the code generator can still generate what appear to be 18-bit program-counter relative-branch instructions, but that the loader (or equivalent) can convert these program-counter relative-displacements into semi-absolute addresses once the memory address is determined when the semi-absolute branch instruction 400 is loaded into memory.

When the semi-absolute branch instruction 400 is loaded into the memory (as is subsequently discussed), there are three situations: 1) the higher bit-range of the instruction's program-counter will not change whether or not the branch is taken; 2) the higher bit-range of the instruction's program-counter will be incremented to reach the branch target address; and 3) the higher bit-range of the instruction's program-counter will be decremented to reach the branch target address. Situations 2 and 3 cause an incremental change in the higher bit-range of the program-counter. The incremental change can be performed by an incrementer logic regardless of whether the change is by plus or minus one.

If, after calculating the branch target address, the branch target address has the same value in bits [63-18] as the higher bit-range of the program-counter of the semi-absolute branch instruction 400 (situation 1), the lower bit-range of the branch target address is loaded into the partial address 407 and the semi-absolute branch instruction adjust bit 411 is cleared. When the semi-absolute branch instruction 400 is executed, the branch target address is effectuated by replacing the lower bit-range of the instruction's program-counter with the value of the partial address 407 from the semi-absolute branch instruction 400.

If, after calculating the branch target address, the branch target address has a different value in bits [63-18] than the higher bit-range of the program-counter for the semi-absolute branch instruction 400 (situations 2 and 3), the semi-absolute branch instruction adjust bit 411 is set to indicate that higher bit-range of the program-counter will have an incremental change on the branch. Whether the incremental change is plus or minus one is controlled by the value of the partial address sign bit 409. When the semi-absolute branch instruction 400 is executed, the branch target address is effectuated by replacing the lower bit-range of the instruction's program-counter with the value of the partial address 407, and if the semi-absolute branch instruction adjust bit 411 is set, incrementing or decrementing the higher bit-range of the program-counter responsive to the value of the partial address sign bit 409.

Thus, the construction of the semi-absolute branch instruction 400 for execution by a computation processor includes determining a program-counter value from where the semi-absolute branch instruction 400 will be executed, as well as determining a branch target address that will replace the program-counter value if execution of the semi-absolute branch instruction causes a branch. In addition, the partial address 407 is set to the lower program-counter value of the branch target address, and the semi-absolute branch instruction adjust bit 411 value is set responsive to whether the higher program-counter value of the program-counter value (corresponding to the higher bit-range of the program-counter) is to change on the branch. The opcode portion 403, and the semi-absolute branch instruction operand 405 (that includes the partial address 407 and the semi-absolute branch instruction adjust bit 411) are assembled into a sequence of bits and stored in the memory at a memory address that corresponds to the program-counter value from which the semi-absolute branch instruction 400 is executed.

When the disclosed technology is applied to the SPARC architecture, the 43-bit incrementers currently used by a SPARC-v9 implementation in the fetch and execution stages continue to be needed. However, the 19-bit adders in the fetch stage 201 and the branch unit adder 211 are eliminated and replaced by significantly simpler logic. This simplification reduces power consumption, uses less chip real-estate, and reduces evaluation latency. Evaluation latency is reduced because the addition to determine the branch target address has already been performed in software.

Notice that if the page size is the same as the maximum displacement, the semi-absolute branch instruction adjust bit 411 directly indicates whether the branch target address is within the same page as the semi-absolute branch instruction 400. Thus, for some configurations, the semi-absolute branch instruction adjust bit 411 can indicate page transitions. Thus, the page transition logic 215 can be simplified by the use of the semi-absolute branch instruction 400.

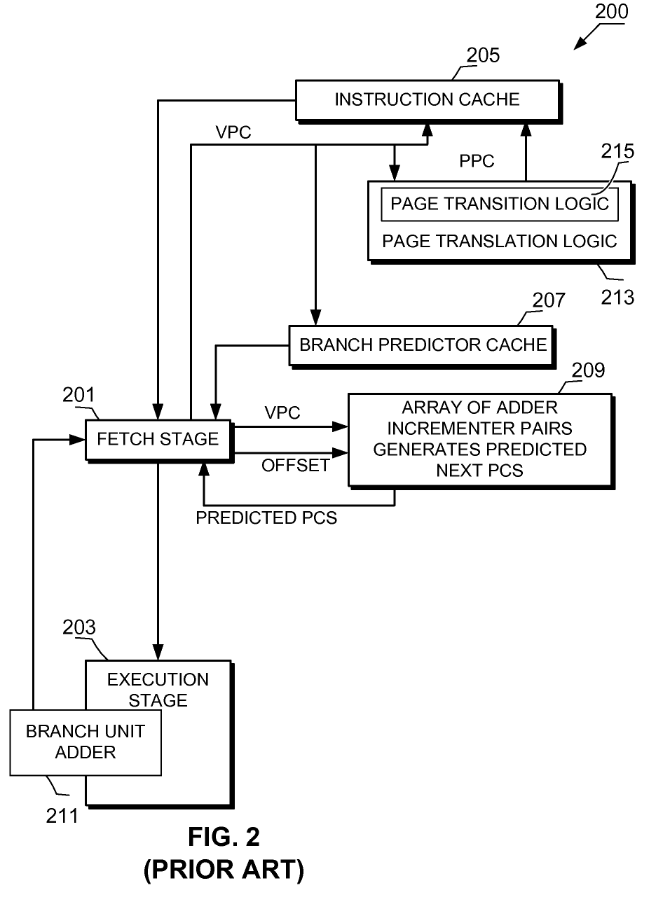

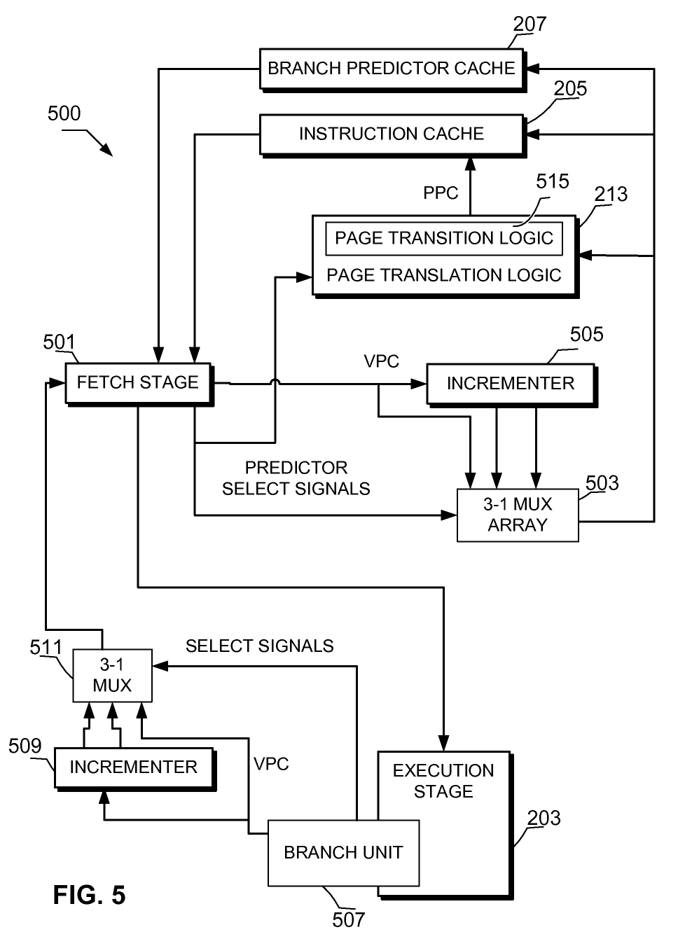

FIG. 5 illustrates a pipeline 500 that can be used to implement the semi-absolute branch instruction 400. The pipeline 500 includes a fetch stage 501 that communicates with the instruction cache 205 and the branch predictor cache 207 as previously described with respect to FIG. 2. Instructions from the bundle of instructions fetched by the fetch stage 501 flow to the execution stage 203 where they are executed. However, the fetch stage 501 also provides the virtual program-counter (VPC) for the current bundle of instructions to a higher-bit-range multiplexer array 503 and an incrementer 505. The incrementer 505 can generate both incremented and decremented values of the higher bit-range of the program-counter. The unchanged, incremented, and decremented values of the higher bit-range of the program-counter are provided to the higher-bit-range multiplexer array 503. Depending on the branch prediction logic in the fetch stage 501 and the semi-absolute branch instruction adjust bit 411 and the partial address sign bit 409 of the semi-absolute branch instruction 400 being predicted, a higher bit-range selection logic in the fetch stage 501 provides predictor select signals to the higher-bit-range multiplexer array 503 to select one of the higher bit-range values of the program-counter for a predicted branch target for each branch prediction. Note that the incremented and decremented higher bit-range values can be used for all of the branch instructions in the bundle of instructions. One skilled in the art will understand that if the fetch stage 501 is configured to only predict one branch instruction from the bundle of instructions, the higher-bit-range multiplexer array 503 can include a single multiplexer. This design reduces the latency related to branch prediction.

A similar operation is performed by a branch execution logic 507 when invoked by the execution stage 203. The branch execution logic 507 is in communication with an execution-stage incrementer 509 and an execution-stage higher-bit-range multiplexer 511.

Like the prior art pipeline 200, the pipeline 500 includes the page translation logic 213. However, the pipeline 500 includes an improved page transition logic 515. Using the ‘predictor select signals’ from the fetch stage 501 allows the improved page transition logic 515 to immediately determine if a page transition is predicted (that is, the predictor select signals indicate whether the higher bit-range value will remain the same or will be subject to incremental change). If the higher bit-range value remains the same, there is no page transition. A page transition is needed if the higher bit-range value changes (issues related to page sizes that are different from the maximum displacement are subsequently discussed, and corresponding modifications can be made to the improved page transition logic 515).

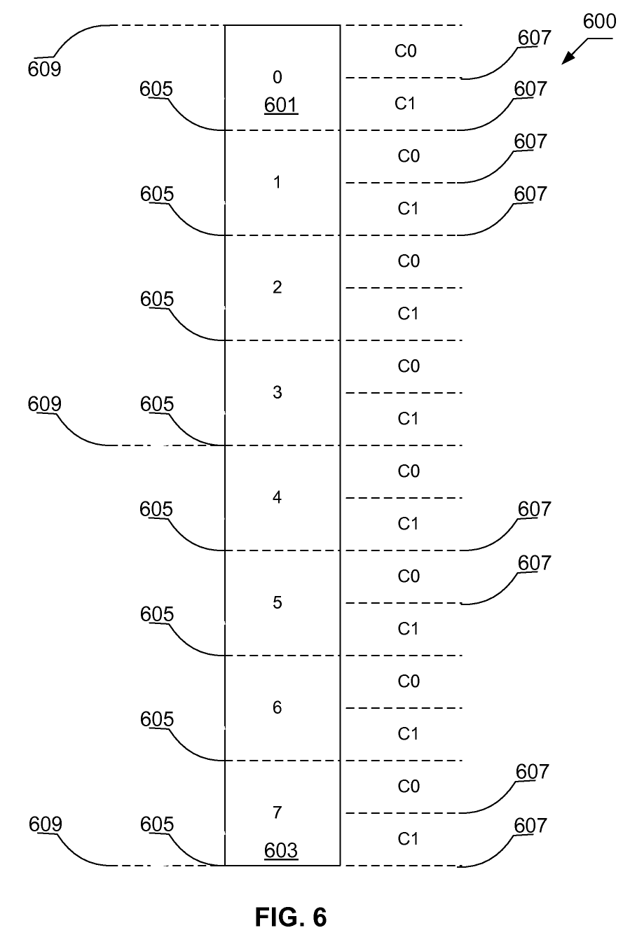

As previously discussed, the use of the semi-absolute branch instruction 400 can simplify the improved page transition logic 515. FIG. 6 illustrates an array of contiguous virtual pages 600. If a page 0 601 through a page 7 603 are pages with an 18-bit address space (providing pages that are 256K bytes long with a page boundary 605 between adjacent pages), then the semi-absolute branch instruction adjust bit 411 directly indicates that a branch to the branch target crosses a page boundary, thus simplifying the improved page transition logic 515. However, in some computation processor embodiments, the page size may not be matched to the maximum displacement.

If the virtual pages are smaller than the maximum displacement of the semi-absolute branch instruction 400 as indicated by a smaller page boundary 607, the semi-absolute branch instruction 400 can still be used. One way is to limit the maximum displacement for the semi-absolute branch instruction 400 to match that of the page size. For example, if the pages have a 13-bit address space (providing pages that are 8K bytes long), the maximum displacement can be constrained by a compiler to 13 bits. The remaining 5 bits in the semi-absolute branch instruction operand 405 can be used as a 5-bit program-counter carry-out to provide a hybrid program-counter-relative target address in the upper 51 bits, and a semi-absolute partial address in the lower 13 bits. Note that such an embodiment extends the semi-absolute branch instruction adjust bit 411 to a set of carry-out and borrow bits. This hybrid implementation allows relocation of memory resident libraries, for example, onto existing 13-bit pages under the same code relocation constraints currently used by loaders of SPARC-v9 code.

Another way to handle virtual pages that are smaller than the maximum displacement of the semi-absolute branch instruction 400 is by an addition of a parallel comparator to the improved page transition logic 515. For example, assuming the pages have a 13-bit address space (providing pages that are 8K bytes long) and the maximum displacement is 18 bits, if the semi-absolute branch instruction adjust bit 411 is set, then the branch target crosses a page boundary. However, if the semi-absolute branch instruction adjust bit 411 is not set, a 5-bit parallel comparator for the higher bits of the lower bit-range can be added to the improved page transition logic 515 and used to determine whether the branch target crosses a smaller page boundary 607.

In addition, pages can be colored such that code relocated to execute in a C0 portion of a page can execute in a C0 portion of any page. For example, code that has been relocated to execute in the C0 portion of the page 0 601 can also be loaded without relocation into the C0 portion of the page 7 603. However, that code would need to be relocated to execute in a portion of a page that is another color, such as a C1 portion of any page.

For larger pages, for example pages having a 20-bit address space (providing pages that are 1024K bytes long with a larger page boundary 609 between adjacent pages), if the semi-absolute branch instruction adjust bit 411 is not set, then there was not a page transition. If the bit is set, then a comparison of the lower two bits of the higher bit-range current program-counter with the incremented/decremented program-counters from the incrementer 505 indicate whether a page transition has occurred. Notice that the incrementer 505 operates in parallel with the fetch of the bundle of instructions. Thus, the page transition determination is also parallelized with the fetch.

Shared memory code libraries that can be shared among applications can use the semi-absolute branch instruction 400 if the shared memory code libraries are stored aligned on a page boundary (as will be understood by one skilled in the art with appropriate adjustment for the previously described smaller and larger pages).

One aspect of the disclosed technology is that the instruction set is not position-independent. As each semi-absolute branch instruction 400 is loaded into memory, the partial address can be computed with respect to the virtual address for the memory that holds the semi-absolute branch instruction 400. This can complicate and/or delay the loading of an application into memory. Where the application is seldom re-loaded into memory (for example, such as server-based programs), this delay is insignificant (the server is re-booted, the operating system starts, the server daemons are started, and the daemons run for many days until the server is re-booted). Some additional load-related issues and approaches are subsequently described.

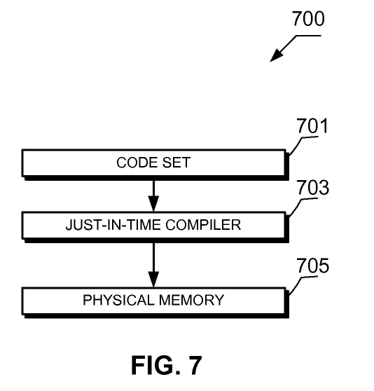

FIG. 7 illustrates a virtual machine loading process 700 that can be used to compile and load the semi-absolute branch instruction 400 into memory. In this process, a program code statement set 701 is processed by a compiler (such as a just-in-time compiler 703) that can be invoked by a virtual machine system such as a Java™ Runtime Environment. The just-in-time compiler 703 is known to one skilled in the art. The just-in-time compiler 703 can be used to compile an often-executed portion of the program code statement set 701 into native computer instructions that can be executed by the actual computation processor that hosts the virtual machine system (instead of being interpreted by the virtual machine). The just-in-time compiler 703 loads the compiled computer instructions into a physical memory 705. Because the just-in-time compiler 703 knows where the semi-absolute branch instruction 400 will be located in physical memory, it constructs the contents of the semi-absolute branch instruction operand 405 accordingly. There is no “re-location” because the semi-absolute branch instruction 400 is compiled for storage at a specific memory address at the time it is stored in the physical memory 705.

Techniques can be used to improve the program loading process for a traditional compiler/linker/loader usage. For example, the compiler can generate position-independent code in object files; the linker can collect objects and libraries (both disk-resident and memory-resident libraries), determine the linkages between them, and generate a load file that can be loaded into the physical memory 705. The loader can read the load file, relocate if needed, establish the actual linkages between the code and library modules, and store the relocated code into the physical memory 705. This description is summary in nature and many omitted details are known to one skilled in the art.

This loading technique can be augmented in that some operating systems provide utilities (for example, the crle utility or the rebase utility) to build and store pre-relocated static load images. These pre-relocated load images can remove or reduce the relocation burden on the loader.

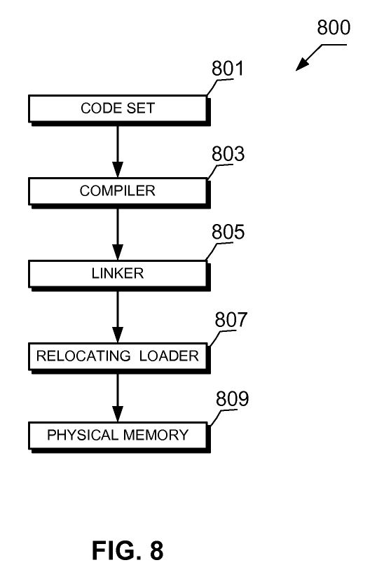

FIG. 8 illustrates a relocating loader process 800 that can be used to compile and load the semi-absolute branch instruction 400 into memory. In this process, a program code statement set 801 can be processed by a compiler 803 to create object files that contain branch instructions with an 18-bit maximum displacement from the program-counter (for example, in the SPARC modification previously described, these branch instructions can be the BPcc instructions having a maximum displacement limited to 18 bits). These object files (and libraries of object files on disk or those that are already loaded into memory) can be assembled/referenced by a linker 805 into a load file that can be loaded into memory by a relocating loader 807. The relocating loader 807 can identify a branch instruction that has a pc-relative displacement and convert it into the semi-absolute branch instruction 400 specific to the memory address where the instruction is stored in a physical memory 809.

As previously discussed, memory-resident code libraries can still be used with the semi-absolute branch instruction 400 if the library is loaded in the physical memory 809 aligned on a boundary that is compatible with the maximum displacement of the branch instructions.

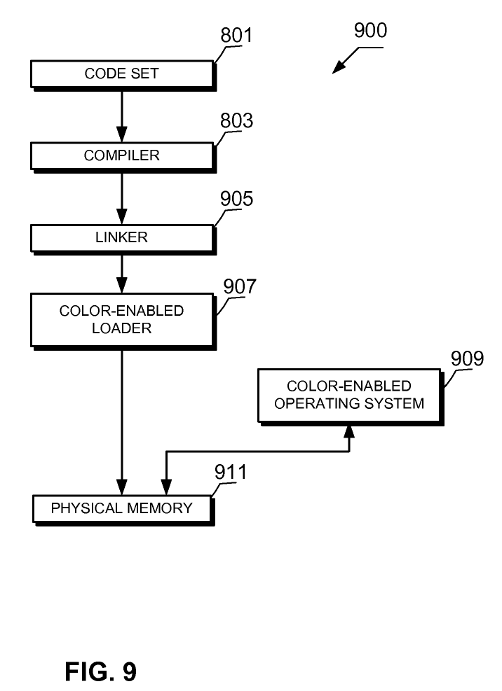

FIG. 9 illustrates a colored memory loading process 900 that again uses the program code statement set 801 and the compiler 803. However, this implementation includes a coloring linker 905 that can create a load file of object files and libraries in a page-color aware manner. A color-enabled loader 907 can load the pages in the load file to appropriately colored pages in the physical memory 911. In addition, a color-enabled operating system 909 can ensure that swapped pages are only reloaded into physical memory pages of the same color as the swapped page.

One skilled in the art will understand that the page color processing can be (as previously described) spread between the coloring linker 905, the color-enabled loader 907 and the color-enabled operating system 909. Such a one will also understand that equivalent embodiments include those where the color page processing is localized in only one of these components as well as distributed differently between the components.

One skilled in the art will understand that the disclosed technology enables more efficient processing of branch instructions in computation processors.

From the foregoing, it will be appreciated that the technology has (without limitation) the following advantages:
1) A faster and more power-efficient branch-instruction for computation processors.
2) A reduction of the real-estate needed in a processor chip for implementation of branch-instruction logic.
3) A faster and more power-efficient detection of page boundary transitions for computation processors.
4) Only minimal changes are needed to code generators to implement the semi-absolute branch instruction.
5) The semi-absolute branch instruction enables most of the branch target address calculation to be performed by the compiler, linker, and loader rather than by the computation processor.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art, which are also intended to be encompassed by the following claims. Unless specifically recited in a claim, steps or components of claims should not be implied or imported from the specification or any other claims as to any particular order, number, position, size, shape, angle, color, or material.

What is claimed follows:

1. An apparatus comprising:
a memory capable of storing a semi-absolute branch instruction at a memory address, said semi-absolute branch instruction comprising a semi-absolute branch instruction opcode, a semi-absolute branch instruction partial address, and a semi-absolute branch instruction adjust bit; and
a computation processor comprising:
a program-counter comprising a lower bit-range and a higher bit-range, said lower bit-range containing a lower program-counter value;
an instruction fetch logic responsive to the program-counter and configured to access said semi-absolute branch instruction from the memory at said memory address covered by said program-counter;
a first instruction decoder logic configured to recognize said semi-absolute branch instruction opcode; and
a first semi-absolute branch instruction logic, responsive to the first instruction decoder logic configured to replace said lower program-counter value of said lower bit-range of said program-counter with said semi-absolute branch instruction partial address.

2. The apparatus of claim 1, wherein said higher bit-range contains a higher program-counter value and the instruction fetch logic further comprises:
an incrementer array logic comprising a decrementer logic configured to provide a decremented higher bit-range value and an incrementer logic configured to provide an incremented higher bit-range value; and
a higher bit-range selection logic configured to select between said higher program-counter value, said decremented higher bit-range value and said incremented higher bit-range value responsive to said semi-absolute branch instruction partial address and said semi-absolute branch instruction adjust bit.

3. The apparatus of claim 2, wherein the computation processor further comprises a page transition logic responsive to said semi-absolute branch instruction partial address and said semi-absolute branch instruction adjust bit.

4. The apparatus of claim 1, wherein the computation processor further comprises:
a second instruction decoder logic configured to recognize said semi-absolute branch instruction opcode; and
a second semi-absolute branch instruction logic, responsive to said second instruction decoder logic configured to replace said lower program-counter value of said lower bit-range of said program-counter with said semi-absolute branch instruction partial address.

5. The apparatus of claim 1, wherein said semi-absolute branch instruction adjust bit is one of a set of carry-out bits.

6. A method for a computation processor to determine a branch target address, said method comprising:
selecting a semi-absolute branch instruction responsive to a program-counter within said computation processor, wherein said semi-absolute branch instruction comprises a semi-absolute branch instruction opcode, a semi-absolute branch instruction partial address, and a semi-absolute branch instruction adjust bit, and wherein said program-counter comprises a lower bit-range and a higher bit-range, said lower bit-range containing a lower program-counter value; and
replacing said lower program-counter value in said lower bit-range with said semi-absolute branch instruction partial address.

7. The method of claim 6, wherein said higher bit-range contains a higher program-counter value and the method further comprises:
incrementing said higher program-counter value to provide an incremented higher bit-range value;
decrementing said higher program-counter value to provide a decremented higher bit-range value; and
selecting between said higher program-counter value, said decremented higher bit-range value and said incremented higher bit-range value responsive to said semi-absolute branch instruction partial address and said semi-absolute branch instruction adjust bit.

8. The method of claim 6, wherein said computation processor is in communication with a memory organized into a plurality of memory pages, said program-counter covering a memory address within a first page of said plurality of memory pages, the method further comprising determining whether said branch target address covers a target memory address within a second page of said plurality of memory pages.

9. A computer-implemented method for constructing a semi-absolute branch instruction for subsequent execution by a computation processor, said computation processor comprising a program-counter, said semi-absolute branch instruction including a semi-absolute branch instruction operand, said method comprising:
determining a program-counter value from where in a memory said semi-absolute branch instruction will be executed by said computation processor;
determining a branch target address that will replace said program-counter value in said program-counter if execution of said semi-absolute branch instruction were to cause said computation processor to branch, said branch target address comprising a lower bit-range containing a lower program-counter value; and
specifying that said semi-absolute branch instruction operand is to contain said lower program-counter value when said semi-absolute branch instruction is stored at a memory address in said memory that corresponds to said program-counter value for execution by said computation processor when said program-counter contains said program-counter value.

10. The computer-implemented method of claim 9, further comprising:
storing said semi-absolute branch instruction in said memory at said memory address with said lower program-counter value in said semi-absolute branch instruction operand.

11. The computer-implemented method of claim 10, wherein the storing is performed by a compiler.

12. The computer-implemented method of claim 10, further comprising reading a load file by a loader and wherein the storing is performed by said loader.

13. The computer-implemented method of claim 10, wherein said memory address is within a colored memory page.

14. The computer-implemented method of claim 9, wherein said branch target address further comprises a higher bit-range containing a higher program-counter value, said method further comprising:
specifying a semi-absolute branch instruction adjust bit responsive to whether said higher program-counter value would be subject to an incremental change if execution of said semi-absolute branch instruction were to cause said computation processor to branch.
